(19) United States
(12) Patent Application Publication
(10) Pub. No.: US 2006/0197996 A1
(43) Pub. Date: Sep. 7, 2006

(54) SCANNER CAPABLE OF SECURING A POSITIVE OR A NEGATIVE ALTERNATIVELY

(76) Inventor: Hsien-Chien Li, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/306,820

(22) Filed: Jan. 12, 2006

(30) Foreign Application Priority Data
Jan. 18, 2005 (TW) 094101462

(51) Int. Cl. H04N 1/04

(52) U.S. Cl. 358/474; 358/509

(57) ABSTRACT

A scanner includes a platform, and an upper casing installed above the platform in a rotatable manner. The upper casing includes a housing including a cavity, and two fixtures positioned above the cavity for receiving an end of a positive respectively when the positive is placed into the cavity in a first direction and for receiving an end of a negative respectively when the negative is placed into the cavity in a second direction. The upper casing further includes a light source disposed inside the housing for emitting light. The scanner further includes a scanning module installed under the platform for receiving light emitted from the light source and passing through the positive or the negative so as to generate a sensing signal.

### BACKGROUND OF THE INVENTION

1. Field of the Invention

The present invention relates to a scanner, and more particularly, to a scanner capable of securing a positive or a negative alternatively.

2. Description of the Prior Art

A scanner is a common kind of computer peripheral. The scanner is used for scanning a document to generate corresponding data. The scanner then transforms the image data into digital data that can be stored and corrected in a computer. Additionally, it can provide some additional functions. For example, the scanner can fax image data to another fax device via a phone, the scanner can transmit e-mail with the image data through a network, or the scanner can print the data via a printer. Moreover, the scanner can put the transformed data on a network. The transmissive scanner is capable of scanning transparent documents, such as slides, negatives, and so on. The transmissive scanner projects light passing through the transparent document so that the image on the transparent document can be transformed into digital data by the transmissive scanner.

Please refer to FIG. 1. FIG. 1 is a diagram of a transmissive scanner 10 in the prior art. The transmissive scanner 10 includes a housing 12 for covering internal components. A platform 14 is installed on the housing 12 for supporting a document. The transmissive scanner 10 further includes an upper casing 16 installed above the platform 14 in a rotatable manner for pressing the document positioned on the platform 14. The upper casing 16 includes a housing 18, and a light source 20 installed inside the housing 18 for emitting light. There is a scanning module (not shown in FIG. 1) installed inside the housing 12 for receiving the light emitted from the light source 20 and passing through the document for generating a corresponding sensing signal.

The transmissive scanner 10 further includes a fixture 22 positioned on the platform 14 for securing the document to be scanned. The fixture 22 includes a positive fixing hole 24 for securing a positive, such as a slide, and a negative fixing unit 26 including two plates 28 and a negative hole 29 for securing a negative, such as a photographic negative. When a positive is scanned, the fixture 22 is positioned on the platform 14 and the positive is positioned inside the positive fixing hole 24. When a negative is scanned, the fixture 22 is positioned on the platform 14 and the negative is positioned under the plates 28 so that the scanning area of the negative aims at the negative hole 29. However the fixture 22 of the transmissive scanner 10 in the prior art is installed in a detachable manner with the main body of the transmissive scanner 10. It is inconvenient to join the fixture 22 with the assembly.

Please refer to FIG. 2 and FIG. 3. FIG. 2 is a diagram of securing a positive with a transmissive scanner 30 in the prior art. FIG. 3 is a diagram of securing a negative with the transmissive scanner 30 in the prior art. The transmissive scanner 30 includes a housing 32 for covering internal components. There is a platform 34 installed on the housing 32 for supporting a document. The transmissive scanner 30 further includes an upper casing 36 installed above the platform 34 in a rotatable manner for pressing the document positioned on the platform 34. The upper casing 36 includes a housing 38, and a light source 40 installed inside the housing 38 for emitting light. There is a scanning module (not shown in FIG. 3 and FIG. 4) installed inside the housing 32 for receiving the light emitted from the light source 40 and passing through the document for generating a corresponding sensing signal. The transmissive scanner 30 further includes a positive fixture 42 installed on the bottom surface of the upper casing 36 for securing a positive, and a negative fixture 44 installed on the positive fixture 42 in a detachable manner. When a positive is scanned, the negative fixture 44 can be removed from the positive fixture 42 and the positive is positioned inside the positive fixing fixture 42. When a negative is scanned, the negative fixture 44 is installed on the positive fixture 42 and the negative is positioned inside the negative fixture 44. However, the positive fixture 42 and the negative fixture 44 of the transmissive scanner 30 in the prior art are detachable, and it is inconvenient to join the negative fixture 44 with the assembly.

### SUMMARY OF THE INVENTION

It is therefore a primary objective of the claimed invention to provide a scanner capable of securing a positive or a negative alternatively for solving the above-mentioned problem.

According to claimed invention, a scanner includes a platform, and an upper casing installed above the platform in a rotatable manner. The upper casing includes a housing including a cavity, and two fixtures positioned above the cavity for receiving an end of a positive respectively when the positive is placed into the cavity in a first direction and for receiving an end of a negative respectively when the negative is placed into the cavity in a second direction. The upper casing further includes a light source disposed inside the housing for emitting light. The scanner further includes a scanning module installed under the platform for receiving light emitted from the light source and passing through the positive or the negative so as to generate a sensing signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a transmissive scanner in the prior art.

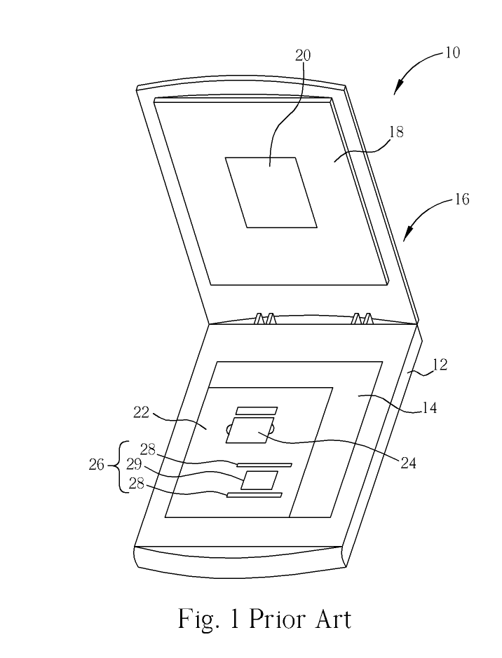

FIG. 2 is a diagram of securing a positive with a transmissive scanner in the prior art.

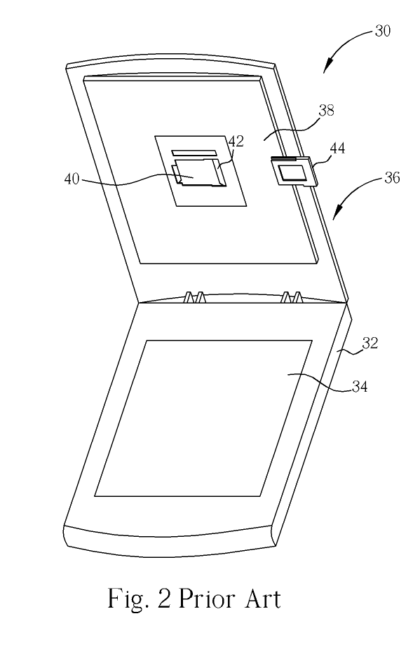

FIG. 3 is a diagram of securing a negative with the transmissive scanner in FIG. 2 in the prior art.

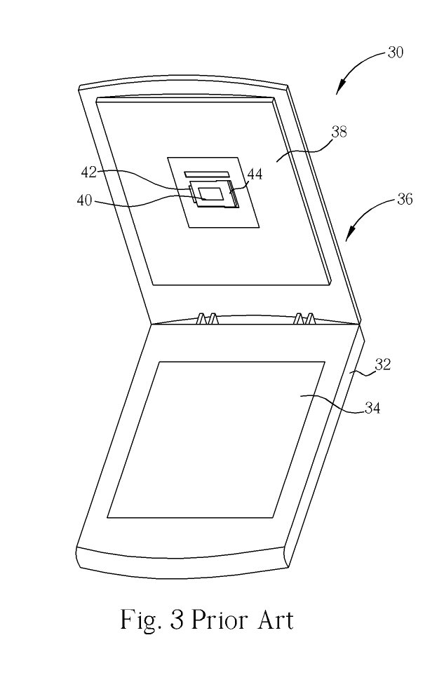

FIG. 4 is a diagram of a transmissive scanner according to the present invention.

FIG. 5 is an enlarged diagram of the mechanism capable of securing a positive or a negative of an upper casing according to the present invention.

FIG. 6 illustrates a fixture of another embodiment according to the present invention.

FIG. 7 is a diagram of a positive being placed into the upper casing according to the present invention.

FIG. 8 is a diagram of a negative being placed into the upper casing according to the present invention.

### DETAILED DESCRIPTION

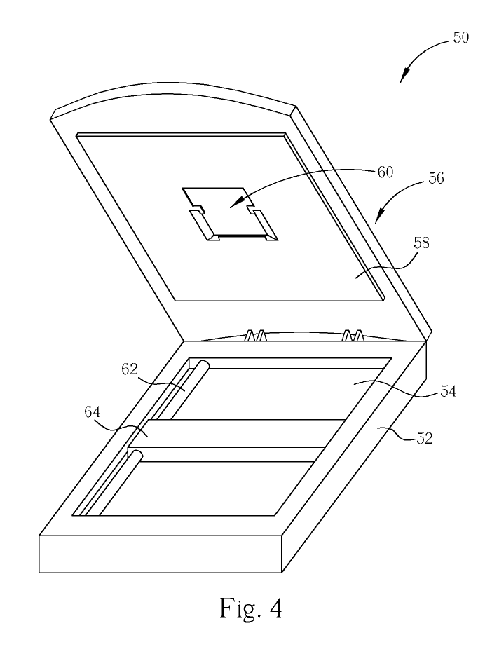

Please refer FIG. 4. FIG. 4 is a diagram of a scanner 50 according to the present invention. The scanner 50 includes a housing 52 for covering internal components. There is a platform 54 installed on the housing 52 for supporting a document. The scanner 50 further includes an upper casing 56 installed above the platform 54 in a rotatable manner for pressing the document positioned on the platform 54. The upper casing 56 includes a housing 58, and a light source 60 installed inside the housing 58 for emitting light. The light source 60 can be a transparent media adapter (TMA), or a light plate. An opening is positioned on the housing 58, and the light emitted from the light source 60 can penetrate the upper casing 56 via the opening. The scanner 50 further includes a shaft 62 installed inside the housing 52, and a scanning module 64 set on the shaft 62 and able to move along the shaft 62 for receiving the light emitted from the light source 60. The light passes through the document and the scanning module generates a corresponding sensing signal. The scanning module 64 can be a contact image sensor (CIS).

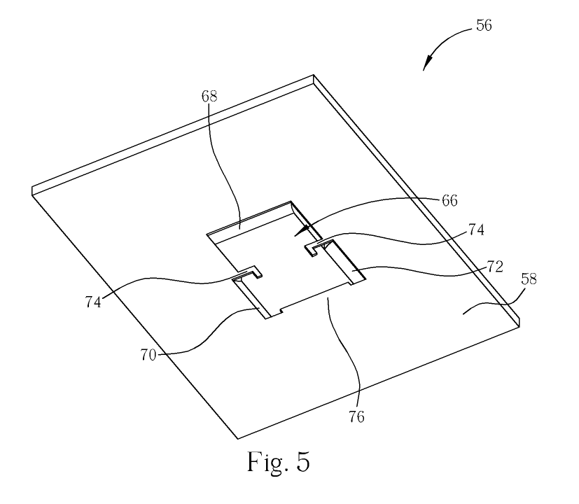

Please refer to FIG. 5. FIG. 5 is an enlarged diagram of the mechanism on the upper casing 56 for receiving and securing a positive or a negative according to the present invention. The housing 58 of the casing 56 includes a cavity 66, and a first inclined surface 68, a second inclined surface 70, and a third inclined surface 72 are formed from the bottom surface of the housing 58 to the bottom of the cavity 66 inwardly. In addition, the housing 58 of the upper casing 56 further includes two fixtures 74 connected to the edge of the cavity 66. The fixture 74 can be an L-shape baffle. The upper casing 56 further includes a baffle 76 formed on the edge of the cavity 66.

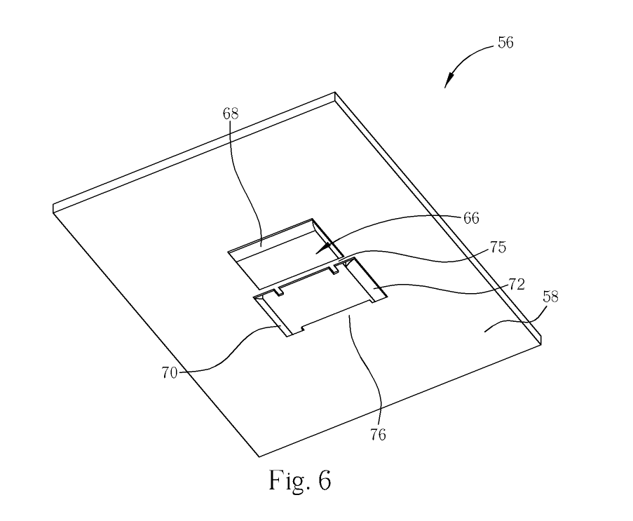

The fixture 74 can instead be a rib extending across the cavity 66. Please refer to FIG. 6. FIG. 6 illustrates a fixture 75 of another embodiment according to the present invention. The both ends of the fixture 75 are connected to the edge of the cavity 66. The difference between the fixture 74 shown in FIG. 5 and the fixture 75 shown in FIG. 6 is that the fixture 75 is a rib extending across the cavity 66 and the fixture 74 does not cross the cavity 66 completely. The fixture 75 also contains L-shaped protrusions for securing a negative.

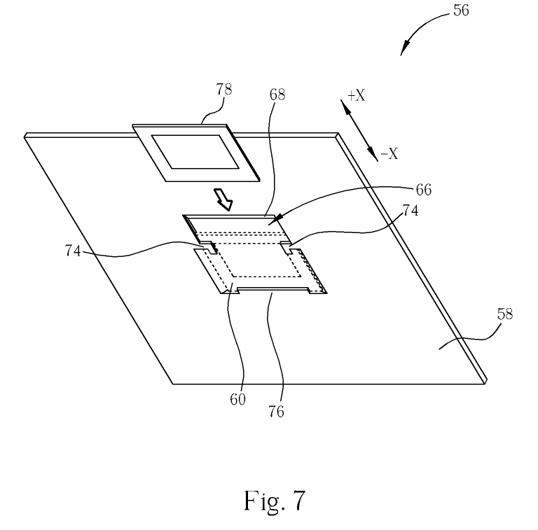

Please refer to FIG. 7. FIG. 7 is a diagram of a positive 78 being placed into the upper casing 56 according to the present invention. The positive can a slide. When the positive 78 is scanned, the positive 78 can be inserted into the cavity 66 along the first inclined surface 68 in the −X direction. The edges of the positive 78 are fixed by the two fixtures 74 and the baffle 76 so that the positive 78 can be fixed under the bottom surface of the housing 58. The securing location of the positive 78 is positioned corresponding to the position from which the light source 60 emits the light, so that the light goes through the positive 78 and thus the scanning module 64 (not shown in FIG. 7) can receive the light emitted from the light source 60 and generate a corresponding sensing signal. The positive 78 can be drawn out along the first inclined surface 68 from the cavity 66 in the +X direction. The deepness of the cavity 66 and the distance between the bottom of the cavity 66 and the two fixtures 74 or the baffle 76 depends on the thickness of the positive 78. For example, the deepness of the cavity 66 can be equal to the thickness of the positive 76 so that the positive 78 inserted into the cavity 66 and fixed by the two fixtures 74 and the baffle 76 can be wedged inside the cavity tightly.

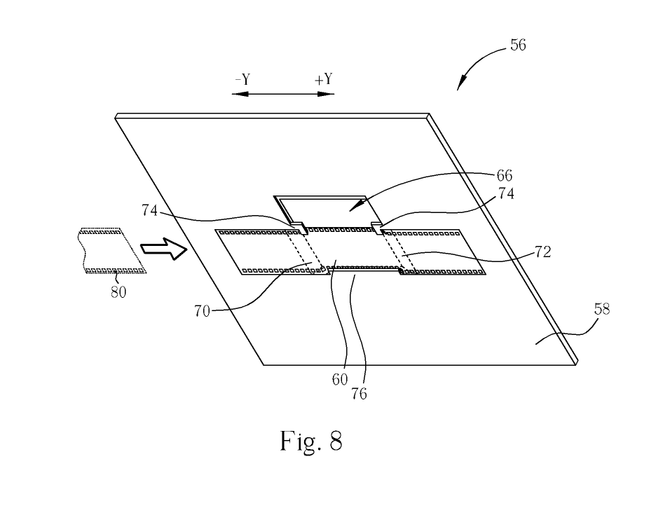

Please refer to FIG. 8. FIG. 8 is a diagram of a negative 80 being placed into the upper casing 56 according to the present invention. The positive can be replaced by a photographic negative. When the negative 80 is scanned, the negative 80 can be inserted into the cavity 66 along the second inclined surface 70 in the +Y direction downward, the two sides of the negative 80 are passed under the two fixtures 74 and the baffle 76 respectively, and then the negative 80 is drawn out along the third inclined surface 72 upwardly. Otherwise the negative 80 can be inserted into the cavity 66 along the third inclined surface 72 in the −Y direction downward, the two sides of the negative 80 are passed under the two fixtures 74 and the baffle 76 respectively, and then the negative 80 is drawn out along the second inclined surface 70 upwardly. The edges of the negative 80 are fixed under the two fixtures 74 and the baffle 76 so that the negative 80 can be fixed under the bottom surface of the housing 58. The securing location of the negative 80 is positioned corresponding to the position from which the light source 60 emits the light, so that the light goes through the negative 80 and thus the scanning module 64 (not shown in FIG. 8) can receive the light emitted from the light source 60 and generate a corresponding sensing signal. The negative 80 can be drawn out from the cavity 66 along the third inclined surface 72 in the +Y direction or along the second inclined surface 70 in the −Y direction. The X direction is perpendicular to the Y direction.

In contrast to the conventional scanner, the securing mechanism for securing a positive or a negative to the scanner according to the present invention is fixed to the upper casing in a monolithic structure. The present invention can eliminate the inconvenience of losing the positive fixture or the negative fixture due to the separation of the positive fixture or the negative fixture from the scanner and the inconvenience of having to assemble the positive fixture or negative fixture.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A scanner comprising:
a platform;
an upper casing installed above the platform in a rotatable manner, the upper casing comprising:
a housing comprising a cavity; and at least one fixture, at least one end of the fixture being connected to the edge of the cavity, for receiving a positive when the positive is placed into the cavity in a first direction and for receiving a negative when the negative is placed into the cavity in a second direction;
a light source disposed inside the housing and located in a position corresponding to the cavity for emitting light; and
a scanning module installed under the platform for receiving light emitted from the light source, the light passing through the positive or the negative and the scanning module generating a sensing signal accordingly.

2. The scanner of claim 1 wherein the fixture is an L-shape baffle.

3. The scanner of claim 1 wherein the housing further comprises a baffle formed on the edge of the cavity for securing an end of the positive when the positive is placed into the cavity in the first direction and for securing an end of the negative when the negative is placed into the cavity in a second direction.

4. The scanner of claim 1 wherein the housing further comprises a first inclined surface formed on one side of the cavity for assisting the positive in being placed into the cavity in the first direction or drawn out from the cavity.

5. The scanner of claim 1 wherein the housing further comprises a second inclined surface and a third inclined surface formed on both sides of the cavity respectively for assisting the negative in being placed into the cavity in the second direction or drawn out from the cavity.

6. The scanner of claim 1 wherein the first direction is perpendicular to the second direction.

7. The scanner of claim 1 wherein the light source is a transparent media adapter (TMA).

8. The scanner of claim 1 wherein the light source is a light plate.

9. The scanner of claim 1 wherein the positive is a slide.

10. The scanner of claim 1 wherein the negative is a photographic negative.
